(19) United States
(12) Patent Application Publication
(10) Pub. No.: US 2015/0032469 A1
(43) Pub. Date: Jan. 29, 2015

(54) System And Method For Cashless Transaction For Availing Hospitalization Benefits

(71) Applicant: Gopal Verma, Gurgaon (IN)

(72) Inventor: Gopal Verma, Gurgaon (IN)

(73) Assignee: E-MEDITEK GLOBAL PRIVATE LIMITED, Gurgaon (IN)

(21) Appl. No.: 14/445,832

(22) Filed: Jul. 29, 2014

(30) Foreign Application Priority Data
Jul. 29, 2013 (IN) 2249/DEL/2013

(51) Int. Cl. G06Q 40/08; G06Q 50/22; G06Q 20/10

(52) U.S. Cl. CPC G06Q 40/08; G06Q 50/22; G06Q 20/10
USPC 705/2

(57) ABSTRACT

A system and method for cashless transaction for availing hospitalization benefits has a point of service transaction terminal for receiving access card data and hospitalization data; a third party administrator or an insurance company desk for entering and transmitting hospitalization data and access card data to an administrator or an insurance company; a storage media for storing the hospitalization and access card data; the third party administrator or the insurance company having an adjudicating element to determine eligibility and accordingly authorizing a value of amount; and a health service provider network connecting the third party administrative or the insurance company and the storage medium; wherein, the access card is inserted into the point of service transaction terminal after availing the hospitalization benefits to read the stored amount, deduct the amount spent and retransmitting the unspent value to the third party administrator or the insurance company.

### FIELD OF THE INVENTION

The present disclosure relates to a system and method for Pre-Authorization of the assured benefits, generated at the hospitalization end at the point of service transaction terminal, and more particularly, to a system and method for generating the Pre-Authorization for the assured benefits within a few seconds using an access card at point of service transaction terminal at the time of admission of customer (patient) and providing a payment settlement at the point of service transaction terminal at the time of discharge.

### BACKGROUND OF THE INVENTION

Pre-Authorization process for approving the Health benefits under employers/insurers schemes has been prevailing over three decades worldwide and about a decade in India. Though there is substantial technological advancements however for complexity of health benefits administration over 90% of process is dependent on Fax machine/Fax module interface while 10% use internet website to transmit information at both ends. The said process takes a few hours to over a day at times.

The current market research reveals, 34% of health care expenditure in India is by way of health care financing schemes, that's when the insurance penetration level is less than 15% which includes CGHS, ESI and Railways. It is believed that the percentage share shall increase significantly with the increased insurance penetration in the country. The break-up of the 34% is further bifurcated as 7% self Insured, 12% ESI/CGHS, 10% others/PSG Self Management Scheme, 5% Government Mass-Scheme.

Though the Cash Less service under insurance and other referred schemes here above have stabilized to a large extent however the customer expectation has also increased with the time. Unfortunately there is no significant progress towards product evolution as most of the products in the market are different variant of age old vanilla “Mediclaim” policy that was introduced in 1986 and revised in middle of 90's. The very nature of the prevalent product is failing to win the confidence of the insuring population at large which is considered a barrier for faster growth of the health insurance in the country.

The experience of availing the Cash Less facility at hospital also differ from person to person and there are situations that it takes more than 24 hours while 4 hours is considered reasonable time to get through the process and have clearance for the treatment. At times delays in cash less add to the cost of treatment with additional day of hospitalization.

The average credit realization period for hospitals remain in excess of 50 days against the agreed 21-28 days for corporate hospitals while for unorganized sector providers its averages beyond 60 days. As a result most hospitals have built a finance cost of administration to follow up for payment and both put together the hospital tariffs are jacked up by approximately 15%. Though the RTGS and NEFT has brought in some dynamism in the payment mechanism but both does not suit the very requirement due to time gap in execution of payment, realization reconciliation as customer may not wait at the hospital at the hospital counter.

US 2007/0005402 discloses a system and method for paying health care charges from multiple source of payments. The patient first seeks treatment from a provider and then provides the presentation instrument or card at the point of service terminal where the patient's treatment charge is to be processed. While the disclosed system does nothing to substantially improves the delay in settling the balances due at the time of discharge.

U.S. Pat. No. 6,208,973 discloses a point of service third party adjudicated payment system and method which provides for the creation of an adjudicated settlement transaction at a point of service which designates the portion of the service to be paid by the third party payer and the portion to be paid by the customer. The point of service terminal includes an internet connection to a node containing an internet merchant bank which is to process the Payment transaction via a credit card, debit card, prepaid card or net banking network in a conventional manner. However, this process is not only for credit card but also for Bank Account and Internet Banking. The adjudication is completed within seconds of an interactive claims submission and settlement reached within a day or two. However, no technique for adjudicating the claims at the point of service transaction terminal at the time of admission is disclosed. For an individual provider, the delay in receiving such payments can be a significant burden.

US 2012/0215553 discloses a method and system identifying health care providers who are authorized to submit health care claims to health insurer or claims processor. The invention discloses algorithms to compare information from provider's credit card terminal to information by insurance company and identifying beneficiaries and dependents who are eligible to receive services capturing health care encounter at point of service, and capturing location and time of health care encounter of authorized beneficiary or dependent at the authorized location of a provider. Many a times the service provider are unable to confirm the permitted charge until after a claim is submitted and adjudicated by the third party administrator or Insurance Company.

WO 2012/174643 discloses a method of claim adjudication by online submitting a claim by service provider at an adjudicators website. The service provider inputting data required by online prompts. Real time online analysis and adjudication of input data and claim to determine if claims meet the adjudicator's preselected criteria. If the claim is accepted, payment is received at a point of sale terminal by inputting the card multiple times at the point of sale terminal to receive multiple payments from multiple sources. The recent proliferation of web portals has made it easier to commit fraud and abuse. Since claim information sometimes only requires a legitimate insured identification such as social security number for Medicare recipients, researching that information on web portals as made false claims easier to file and be paid.

The disclosure that follows overcomes the drawbacks of the method disclosed in prior arts by providing a method for cashless transactions for availing hospitalization benefits that should advantageously provide a pre-authorization of the assured benefits generated at the hospitalization end at the point of service transaction terminal at the time of admission of a patient and eliminate delay in settling the balances due at the time of discharge.

### SUMMARY OF THE INVENTION

The object of present invention is to provide a system and method for cashless transactions for availing pre-authorization of the assured hospitalization benefits.

Yet another object of the present invention is to provide a system and method that eliminates the delay in settling the balances due at the time of discharge.

According to the preferred embodiment of the present disclosure, there is provided a system for cashless transaction for availing hospitalization benefits comprising: a point of service transaction terminal for receiving access card data and hospitalization data for initializing cashless transaction; a third party administrator or an insurance company desk for entering and transmitting hospitalization data and access card data to a third party administrator or an insurance company; a storage media for storing the hospitalization data and access card data; a third party administrator or an insurance company for receiving the hospitalization data and access card data through a financial switch, the third party administrator or the insurance company being provided with an adjudicating element to determine eligibility and accordingly authorizing a value of amount; and a health service provider network connecting the third party or the insurance company administrative and the storage medium; wherein, the access card is inserted into the point of service transaction terminal after availing the hospitalization benefits for enabling a card reader to read the stored nature of amount, deduct the portion of value of amount spent on providing hospitalization benefits and retransmitting the unspent value to the third party administrator or the insurance company in a predetermined time.

In an embodiment of present disclosure, the access card is selected from the group consisting of general master card, visa, Amex transaction cards and any other payment gateway.

In another embodiment of present disclosure, the health service provider network is operated by a third party administrator or an insurance company and financial switch is operated by an authorized financial service provider.

According to another embodiment of present disclosure, there is provided a method for cashless transaction for availing hospitalization benefits comprising: entering access card information into a point of service transaction terminal for initializing cashless transaction; entering and storing hospitalization information on the storage medium of the terminal; transmitting the hospitalization data and the access card data to an adjudicating element provided by a third party administrator or an insurance company; computing the hospitalization data and the access card data for determining eligibility and authorizing a value of amount for availing the hospitalization benefits; electronically storing the value of amount to the access card for spending at the terminal; inserting the access card into the point of service transaction terminal after availing the hospitalization benefits for enabling the card reader to read the stored nature of amount, deduct the portion of value of amount spent on providing hospitalization benefits and electronically storing the unspent value of amount; and electronically re-transmitting the unspent value to the third party administrator or the insurance company in a predetermined time.

In another embodiment of the present disclosure the access card information is entered manually or by inserting the card at the point of service transaction terminal.

The Non-limiting examples of the hospitalization data may include height, weight and blood group of patient, line of treatment, date of admission, date of discharge, medical history, and estimated expenses including room rent charges, OT charges, anesthetic charge, pharmacy and consumables.

The height and weight of the patient may be entered at the time of admission to calculate the BMI (Body Mass Index) to know the health of the patient, whether patient is healthy, overweight or underweight. This helps the third party administrator (TPA) or the insurance company to evaluate the medication being used for treatment. Further, the blood group of the patient is also entered in order to identify the insurer. Also, it helps in preventing fraud and abuse in health care services.

In another embodiment of the present disclosure the adjudicating element compute the said hospitalization data by predefined logic.

According to yet another embodiment of the present disclosure the predefined logic is based on determination regarding policy status active or inactive, patient covered or not, line of treatment covered or not, pre-existing disease, exemption, availability of sum assured and other eligibility norms defined in insurance policy.

Another embodiment of the present disclosure provides for mapping of Line of treatment with ICD codes. The International Classification of Diseases (ICD) is the standard diagnostic code for treatment availed and same is entered in the point of service transaction terminal while discharge request is submitted. This helps in preventing fraud and also helps to evaluate if the medical procedures given are in line with the treatment.

In another embodiment of the present disclosure the value of amount is linked with a merchant ID of the point of service transaction terminal.

Yet another embodiment of the present disclosure provides a method for cashless transaction for availing hospitalization benefits comprising: entering access card information into a point of service transaction terminal for initializing cashless transaction; entering and storing hospitalization data on the storage medium of the terminal; transmitting the hospitalization data and the access card data to an adjudicating element provided by a third party administrator or an insurance company; computing the hospitalization data and the access card data for determining eligibility and authorizing a value of amount for availing the hospitalization benefits; electronically storing the value of amount to the access card for spending at the terminal; inserting the access card into the point of service transaction terminal after availing the hospitalization benefits for enabling the card reader to read the stored nature of amount, transmitting an information regarding uploading the value of amount in the access card to hospital and card holder, deduct the portion of value of amount spent on providing hospitalization benefits and electronically storing the unspent value of amount; and electronically re-transmitting the unspent value to the third party administrator or the insurance company in a predetermined time.

In a particular embodiment of the present disclosure the information regarding uploading of amount to both hospital/service provider and card holder (customer/patient) via SMS, Email and Telephonic call.

In another embodiment of the present disclosure the unspent value will be re-transmitted within 24 hours from the time it is electronically stored on the access card.

The point of service transaction terminal in accordance with the method of the present disclosure accepts an access card, such as general master card, visa and Amex transaction cards for availing hospitalization benefits. The point of service transaction terminal is used for financial transactions wherein the Hospital TPA Desk or an insurance company executive is entering the access card information manually or by inserting the card at the point of service transaction terminal. The Hospital TPA Desk or the insurance company executive enters the hospitalization data at the point of service transaction terminal including height, weight and blood group of patient, line of treatment, date of admission, date of discharge, medical history, and estimated expenses including room rent charges, OT charges, anesthetic charge, pharmacy and consumables. The hospitalization data along with the card number flows to an adjudicating element/claim processing Application via a switch.

The adjudication of the hospitalization data entered by the Hospital TPA Desk or the insurance company executive by an adjudicating element is substantially done in real time to determine the pre-authorized value of amount for availing the hospitalization benefits. The adjudicating element approves or decline cashless request based on the predefined logic designed at the TPA or the insurance company server. The adjudicating element performs eligibility check based on the predefined logic. The predefined logic is based on determination regarding policy status active or inactive, patient covered or not, line of treatment covered or not, pre-existing disease, exemption, availability of sum assured and other eligibility norms defined in insurance policy. Based on the eligibility the claim is adjudicated and cashless approval information is shared with value of authorized amount. In case, the cashless authorization is declined, the same is conveyed to the service provider with decline reason.

In another embodiment of the present disclosure, at the time of cashless hospitalization approval, only 30% of the estimated amount entered is approved and approval slip is generated. At this stage no amount is transferred to Hospitals or service provider.

Yet another embodiment of the present disclosure provides a method which is not limited to package treatment but open to all line of treatment.

These and other features, aspects, and advantages of the present subject matter will become better understood with reference to the following description. This summary is provided to introduce a selection of concepts in a simplified form. This summary is not intended to identify key features or essential features of the subject matter, nor is it intended to be used to limit the scope of the subject matter.

### BRIEF DESCRIPTION OF THE DRAWINGS

The above and other features, aspects, and advantages of the subject matter will be better understood with regard to the following description, and accompanying drawings where:

FIG. 1: System for cashless transaction for availing hospitalization benefits.

FIG. 2: Process Flow diagram for Cashless Authorization.

FIG. 3: Process Flow diagram for Payment to service provider.

### DETAILED DESCRIPTION OF THE INVENTION

A non-limiting advantageous embodiment of the present disclosure will now be described in detail with reference to Figures. Those skilled in the art will appreciate that the description given herein with respect to the figure is for exemplary purposes only and is not intended in any way to limit the scope of the invention. All questions regarding the scope of the invention may be resolved by referring to the appended claims.

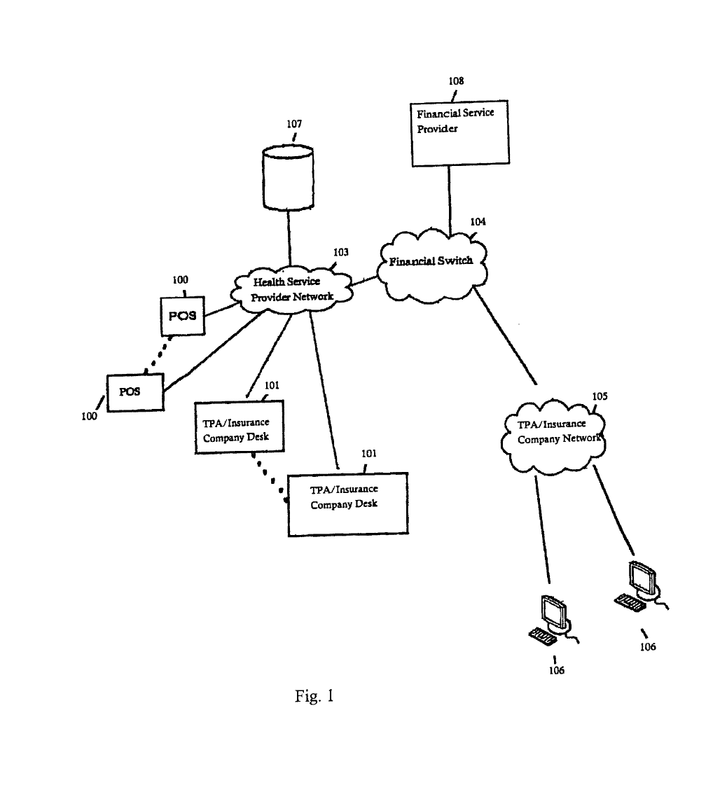

FIG. 1 illustrates a system for cashless authorization for availing hospitalization benefits. A customer (patient) enters the hospital and hand over the card for availing hospitalization benefits to a Hospital TPA or an insurance company desk executive. A system includes a plurality of Point of service transaction terminal (100) and plurality of third part administrator (TPA) or insurance company desk terminals (101). The terminals communicate through a health service provider network (103) operated by a third party or insurance company administrative. The point of service transaction terminal is used for financial transactions wherein the Hospital TPA or the insurance company desk executive is entering the access card information manually or by inserting the card at the point of service transaction terminal. The Hospital TPA or the insurance company desk executive enters the hospitalization data at the point of service transaction terminal. The hospitalization data along with the card number stored in the storage medium (107) flows to a third party administrator or an insurance Company network (105) via a financial switch (104) which is operated by a financial service provider (108). The third party administrator or the insurance company determine the pre-authorized value of amount for availing the hospitalization benefits. The third party administrator or the insurance company approves or decline cashless request based on the predefined logic designed at the TPA or the insurance company server (106) level.

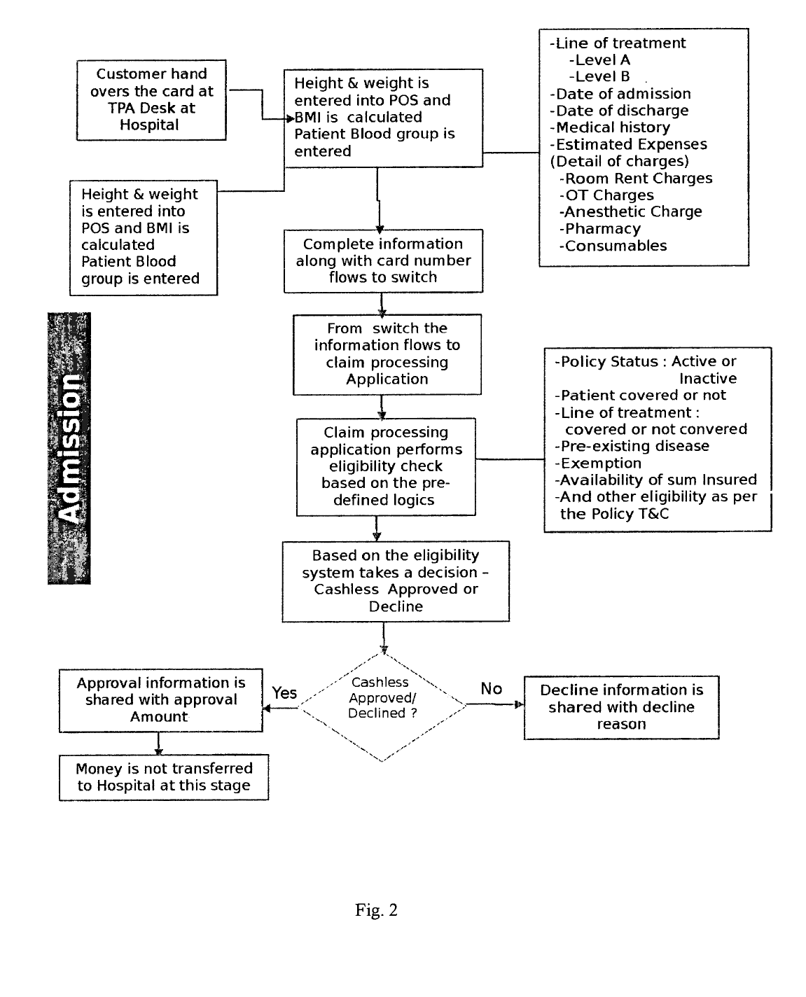

FIG. 2 illustrates a flow diagram for cashless authorization for availing hospitalization benefits at the time of admission of a patient. As illustrated in FIG. 2, a customer (patient) hands over the access card such as general master card, visa and Amex transaction cards for availing hospitalization benefits to a Hospital TPA Desk executive at the time of admission. The point of service transaction terminal is used for financial transactions wherein the Hospital TPA Desk executive is entering the access card information manually or by inserting the card at the point of service transaction terminal. The Hospital TPA Desk executive enters the hospitalization data at the point of service transaction terminal including height, weight and blood group of patient, line of treatment, date of admission, date of discharge, medical history, and estimated expenses including room rent charges, OT charges, anesthetic charge, pharmacy and consumables. The hospitalization data along with the card number flows to an adjudicating element/claim processing Application via a financial switch. The hospitalization data entered by a Hospital TPA Desk executive is adjudicated by an adjudicating element substantially in real time to determine the pre-authorized value of amount for availing the hospitalization benefits. The adjudicating element approves or decline cashless request based on the predefined logic designed at the server level. The adjudicating element performs eligibility check based on the predefined logic. The predefined logic is based on determination regarding policy status active or inactive, patient covered or not, line of treatment covered or not, pre-existing disease, exemption, availability of sum assured and other eligibility norms defined in insurance policy. Based on the eligibility the claim is adjudicated and cashless approval information is shared with value of authorized amount. In case, the cashless authorization is declined, the same is conveyed to the service provider with decline reason.

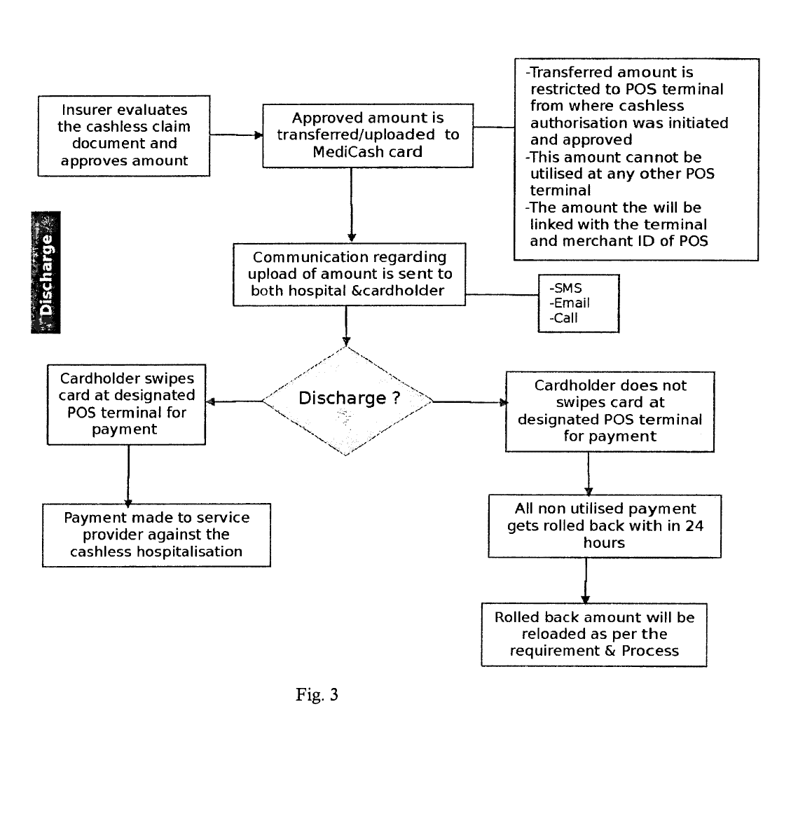

FIG. 3 illustrates a flow diagram for payment to a service provider at the time of discharge of a patient. As illustrated, the value of authorized amount is transferred/uploaded to an access card. The authorized amount is restricted to point of service transaction terminal from where cashless authorization was initiated and approved. Further, the authorized amount is linked with a merchant ID of the point of service transaction terminal. The communication regarding uploading of amount is sent to both hospital/service provider and card holder (customer/patient) via SMS, Email and Telephonic call. At the time of discharge, the card holder swipes the card at the designated point of service transaction terminal for payment. Further, if the card holder does not swipes the card at the designated point of service transaction terminal for payment then all non utilized payment gets rolled back within 24 hours.

### ADVANTAGES OF THE INVENTION

The present disclosure provides a system and method for cashless transactions for availing pre-authorization of the assured hospitalization benefits.

The present disclosure provides a system that eliminates the delay in settling the balances due at the time of discharge.

In addition to above, the present disclosure provides a system that solves the problems associated with fraud and abuse in health care services.

Although the subject matter has been described in considerable detail with reference to certain preferred embodiments thereof, other embodiments are possible. As such, the spirit and scope of the disclosure should not be construed to be limited to the description of the advantageous embodiment contained therein.

What is claimed is:

1. A system for cashless transaction for availing hospitalization benefits comprising:
a point of service transaction terminal for receiving access card data and hospitalization data for initializing cashless transaction;
a third party administrator or an insurance company desk for entering and transmitting hospitalization data and access card data to a third party administrator or an insurance company;
a storage media for storing the hospitalization data and the access card data;
a third party administrator or an insurance company for receiving the hospitalization data and access card data through a financial switch, the third party administrator or the insurance company being provided with an adjudicating element to determine eligibility and accordingly authorizing a value of amount; and
a health service provider network connecting the third party administrator or the insurance company and the storage medium; wherein,
the access card is inserted into the point of service transaction terminal after availing the hospitalization benefits for enabling a card reader to read the stored nature of amount, deduct the portion of value of amount spent on providing hospitalization benefits and retransmitting the unspent value to the third party administrator or the insurance company in a predetermined time.

2. The system as claimed in claim 1, wherein the access card is selected from the group consisting of general master card, visa and Amex transaction cards and any other payment gateway.

3. The system as claimed in claim 1, wherein the network is operated by the third party administrator or the insurance company and the financial switch is operated by an authorized financial service provider.

4. A method for cashless transaction for availing hospitalization benefits comprising:
entering access card information into a point of service transaction terminal for initializing cashless transaction;
entering and storing hospitalization data on the storage medium of the terminal;
transmitting the hospitalization data and the access card data to an adjudicating element provided by a third party administrator or an insurance company;
computing the hospitalization data and the access card data for determining eligibility and authorizing a value of amount for availing the hospitalization benefits;
electronically storing the value of amount to the access card for spending at the terminal;
inserting the access card into the point of service transaction terminal after availing the hospitalization benefits for enabling the card reader to read the stored nature of amount, deduct the portion of value of amount spent on providing hospitalization benefits and electronically storing the unspent value of amount; and
electronically re-transmitting the unspent value to the third party administrator or the insurance company in a predetermined time.

5. The method as claimed in claim 4, wherein the access card information is entered manually or by inserting the card at the point of service transaction terminal.

6. The method as claimed in claim 4, wherein the hospitalization data include height, weight and blood group of patient, line of treatment, date of admission, date of discharge, medical history, and estimated expenses.

7. The method as claimed in claim 6, wherein the estimated expenses include room rent charges, OT charges, anesthetic charge, pharmacy and consumables.

8. The method as claimed in claim 4, wherein the adjudicating element compute the said hospitalization data by predefined logic.

9. The method as claimed in claim 6, wherein the predefined logic is based on determination regarding policy status active or inactive, patient covered or not, line of treatment covered or not, pre-existing disease, exemption, availability of sum assured and other eligibility norms defined in insurance policy.

10. The method as claimed in claim 9, wherein the line of treatment is mapped with ICD code.

11. The method as claimed in claim 4, wherein the value of amount is linked with a merchant ID of the point of service transaction terminal.

12. The method as claimed in claim 4, further comprising transmitting an information regarding uploading the value of amount in the access card to hospital and card holder.

13. The method as claimed in claim 12, wherein the information is transmitted to the hospital and the card holder via SMS, Email and Telephonic call.

14. The method as claimed in claim 4, wherein the unspent value will be re-transmitted within 24 hours from the time it is electronically stored on the access card.
